(19) United States
(12) Patent Application Publication
(10) Pub. No.: US 2016/0364994 A1
(43) Pub. Date: Dec. 15, 2016

(54) METHOD OF REITERATIVE ENQUIRY

(71) Applicants: Matthew Leuchtmann, Columbia, MO (US); Michael Deslongchamps, Wentzville, MO (US)

(72) Inventors: Matthew Leuchtmann, Columbia, MO (US); Michael Deslongchamps, Wentzville, MO (US)

(21) Appl. No.: 15/178,367

(22) Filed: Jun. 9, 2016

Related U.S. Application Data
(60) Provisional application No. 62/174,181, filed on Jun. 11, 2015.

(51) Int. Cl. G09B 5/12; G06F 17/30; G06F 21/10

(52) U.S. Cl. CPC G09B 5/12; G06F 21/105; G06F 17/30312

(57) ABSTRACT

An interactive system allows teachers to implement lesson plans online and in real time and students to receive lessons and undergo testing similarly. The system operates in a secure environment protecting students and the lesson plans of the teachers. Students have limited attention spans and sometimes errant motives while teachers have hectic schedules and numerous requirements to follow. The system captures the attention of students and streamlines lesson plan implementation. The system has at least one server for developing lesson plans, for presenting the lessons to students, for managing teachers' usage of the system and for managing students' usage of the system. The server and related devices cooperatively utilize various means for adding content to lesson plans, delivering the lesson plans to students, and assessing the progress of students towards goals set by teachers for each lesson. The system is deployed upon a client server architecture.

### CROSS-REFERENCE TO RELATED APPLICATION

This non-provisional application claims priority to pending provisional application No. 62/174,181 filed on Jun. 11, 2015, which is owned by the same inventors.

### BACKGROUND OF THE INVENTION

The present invention relates to methods of education. The Method of Reiterative Enquiry has particular utility in providing a network of high quality digital instruction that both enhances teacher performance and increases student achievement.

In recent years, technology, both hardware and software, has advanced at an exponential pace. Many administrators and educators have not received proper trained to combine research based best educational practice with ever evolving technologies. As a result, modern classrooms have not changed much since the industrial revolution.

At present, teachers develop and evaluate curriculum and performance by students using static tools to collect data. That data then enters storage in obscure and often meaningless repositories. Rarely do teachers and administrators mine the data for ways to improve student performance and curriculum development.

The global e-learning market has become a $4.4 trillion industry. The industry includes the entire K-12 market that is, small, medium and large public, private, charter and home schools. The present invention has onboard flexibility to enhance education in all of these sectors. The system was designed by an educator, and a programmer working together with the goal of providing affordable access to the best digital instruction available, in one intuitive network. Since it was designed with best educational practices in mind, teachers and administrators navigate and implement the invention with ease.

Educators have not received proper training to implement ever evolving and expanding e-learning technologies. To prepared for and thrive in the 21st Century global marketplace, students must have training to navigate, validate and create using the powerful tools of e-learning technology.

### DESCRIPTION OF THE PRIOR ART

Many teachers have students of varying motivation, ability, and skill level for select school subjects. Some students excel in one subject then to drag behind in another. A teacher has a classroom full of students at varying levels of progress for a subject. A teacher then manages and deploys his own effort so the most students advance in knowledge about a subject in a given time with given resources. Such an approach may assist most students to progress in knowledge however such an approach may leave a handful of students behind and another handful of students bored. While bringing the most students forward in knowledge, a teacher also has to watch for the outlying slow and fast progressing students. In this era of heightened scrutiny of education and competition from other nations, teachers face significant burdens to educate the most students to the highest level in a cost effective manner.

Various vendors have developed self-paced e-learning modules that a student may use independently of classroom instruction. Such providers of self-paced e-learning modules deliver closed proprietary content through a scope and sequence that often serves as a teacher replacement model. These models de-personalize learning an approach teaching into a rote, mechanical means of transferring knowledge to students.

Though preceding description has referred to school settings, the description also applies to institutions of higher learning, trade schools, seminars, military training, and the like. While the above-described devices fulfill their respective, particular objectives and requirements, the aforementioned devices do not describe a Method of Reiterative Enquiry that develops and implements lesson plans online and in real time in cooperation with teachers and that delivers lessons and academic testing online and in real time to students.

Therefore, a need exists for new and improved Method of Reiterative Enquiry that can be used for best educational practices within a digital network designed to bring all elements together in a quick, flexible, intuitive environment. In this regard, the present invention substantially fulfills this need. In this respect, the Method of Reiterative Enquiry according to the present invention substantially departs from the conventional concepts and designs of the prior art, and in doing so provides a device primarily developed for the purpose of providing a networked repository of high quality learning experiences that utilizes user feedback to evaluate and rank the best lessons and projects for deployment with the global community of education.

The Method of Reiterative Enquiry overcomes the above mentioned disadvantages and drawbacks of the prior art. As such, the general purpose of the present invention, which will be described subsequently in greater detail, is to provide a new and improved Method of Reiterative Enquiry which has all the advantages of the prior art mentioned heretofore and many novel features that result in Method of Reiterative Enquiry which are not anticipated, rendered obvious, suggested, or even implied by the prior art, either alone or in any combination thereof.

### SUMMARY OF THE INVENTION

The Method of Reiterative Enquiry, or Personalized Learning Network, as an interactive system allows teachers to develop and to implement lesson plans online and in real time and students to receive lessons and undergo academic testing online and in real time. The system of the invention operates in a secure environment protecting the activities of the students and the lesson plans of the teachers. Students have limited attention spans and sometimes errant motives while teachers have hectic schedules and numerous requirements to follow. The system of the invention captures the attention of students and streamlines lesson plan development and implementation. The system of the invention has at least one server for developing lesson plans, for presenting the lessons to students, for managing teachers' usage of the system and for managing students' usage of the system. The at least one server and related devices cooperatively utilize various means for adding content to lesson plans, delivering the lesson plans to students, and assessing the progress of students towards goals set by teachers for each lesson. The system can be deployed upon a client server architecture as it keeps both student and teacher using it to conclusion of lesson plans.

The present invention combines best educational practices within an e-learning network designed to bring together digital elements in a flexible, intuitive and reliable environment. Students, parents, teachers and administrators will enjoy the flexibility and ease of access provided by the system as they collaborate through crowd sourced resources, view assignments and feedback, upload lessons, analyze data, and share student achievements.

The present invention is a web application developed utilizing modular programming. Each aspect of system functionality operates as an independent and interchangeable module such that everything necessary for each action of the system can operate independently from the whole. This makes the code much easier to read, maintain, and test. Additionally, by utilizing modular programming, the present invention adjusts to federal, state, and district educational requirements, or other industry demands.

The Method of Reiterative Enquiry begins with these top level modules: Administrator for actions used by school administrators and to manage the invention at an administrative level, Facilitator for actions used by educators, Student for actions used by learners, Parent for actions used by parents of learners, and Contributor for actions used by industry experts.

The present invention interoperates with other systems so that a district user does not become locked into a particular vendor. IMS Global Question and Test Interoperability (QTI) and Common Cartridge standards establish the ability for the present invention to integrate with a school districts existing Student Information Systems, or “SIS,” and Learning Management Systems, or “LMS.” This in turn drives the development of web services containing reports and analytics data from the invention that school districts may utilize with their current SIS or LMS authentication in the form of custom plugins and modules. The IMS Global Common Cartridge standards by IMS Global Learning Consortium of Lake Mary, Fla., provides a template for the invention to import and to export lesson plans for use in other LMS systems such as Blackboard or Canvas. This reduces the amount of vendor lock-in and school districts may import old content into the present invention or export lessons from the present invention into another system of their choice.

The Analytics Engine of the present invention will transform grading and assessment in the 21^{st} century classroom. This analytics engine performs statistical analysis on data captured by the present invention to provide authentic assessment that will provide educators an adaptive approach to understanding individual student learning. This statistical analysis will provide relevant information to students, parents, educators and administrators regarding every level of learning experience within the present invention. Data associated with individual learning achievement and behaviors will allow the system to provide opportunities for adaptive, differentiation of the learning experience. This approach allows educators to capture incremental student growth toward specific standards, skills and objectives.

The present invention has its design and development so it operates on a wide variety of web enabled devices that are available to students, parents, educators and administrators. This allows users to Bring Your Own Device or “BYOD” to the present invention, thereby potentially decreasing costs and increasing overall accessibility. Utilization of modern and commonly accepted web application technologies such as HTML5, CSS3 and the BootStrap UI Library make this accessibility possible. Web enabled devices supported by the invention include smartphones, tablet computers, laptop computers, desktop computers, servers, and the like.

There has thus been outlined, rather broadly, the more important features of the invention in order that the detailed description thereof that follows may be better understood and in order that the present contribution to the art may be better appreciated.

The Method of Reiterative Enquiry may also include an alternate embodiment of the invention with personalized student portfolios driven by educator feedback and learning analytics then capture performance and progress to enhance the standards based approach. The present invention's unique e-portfolio system documents student progress through their courses and grade levels making it easy for parents teachers, administrators and the students themselves to see a clear picture of individual learning profiles. The present invention serves as a global, collaborative, cloud based network that organizes opportunities for students around the world to problem solve, design, innovate and create within the digital environment. The pedagogy and design of the invention underwent development and validation through years of applied standards and project based learning in computer facilitated classrooms across K-12 education. The system represents an innovative approach to application of 21st century skills, providing educators and administrators the tools they need to increase student achievement, and transform the modern classroom. Additional features of the invention will be described hereinafter and which will form the subject matter of the claims attached.

The present invention operates as a global, collaborative online platform that facilitates a network of high quality e-learning experiences developed and implemented through application of research based best educational practice. The network of the invention has a design for teachers to customize digital instruction and assessments in a manner that reflects research based best practice. Lesson development follows best educational practices which helps ensure teachers are creating high quality digital instruction. Facilitators may add lesson plans, projects and create courses, but they can also access content created by other public network contributors. Once a lesson is assigned to a course, instruction and resources are then shared with students allowing them to navigate activities and assessments, which frees up more time for the educator to facilitate learning. Navigate means to follow a planned course through its end.

Student data and progress are then monitored and recorded in individualized e-portfolios that follow them throughout their usage of the present invention. The present invention utilizes cloud computing, storage, metadata and learning analytics to streamline digital course development and implementation. Educators can create lessons utilizing a wide variety of Web 2.0 technology in an efficient, flexible manner. Standards, skills and objectives drive the engine which allows educators to assess learning through demonstration of specific outcomes, rather than obscure percentages. This innovative approach to digital analysis and documentation of standards based grading sets the invention apart from the prior art and makes it unique in the industry. The database and analytic engine module of the invention capture and communicate specific behavioral dispositions and skills of a student associated with learning that go beyond the content itself. Select modules of the invention can also capture and evaluate performance based skills. The invention provides collaborative opportunities for those who wish to participate. This allows students from around the globe an opportunity to create, learn and share together. The invention also provides Project Based Learning experiences are available to guide students and teachers through a variety of problem solving processes. These processes create powerful solutions that users of the invention may rapidly prototype, promote, and share.

The present invention combines research based best practices within a network designed to facilitate application of e-learning technology in a flexible, intuitive and reliable environment. The system facilitates organization of the complex data required to create and capture personalized learning experiences, while monitoring and evaluating both student progress, and educator effectiveness over time. The invention makes e-learning accessible to those in the education industry.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and devices for carrying out the several purposes of the present invention. It is important, therefore, that the claims be regarded as including such equivalent constructions insofar as they do not depart from the spirit and the scope of the present invention.

It is therefore an object of the present invention to provide a new and improved Method of Reiterative Enquiry that allows teachers to create and to adapt content according to student need.

Still another object of the present invention is to provide a Method of Reiterative Enquiry that increases student achievement through data driven instruction informed by learning and accountability analytics;

Still another object of the present invention is to provide a Method of Reiterative Enquiry that allows teachers to create a repository of easy to access customized curriculum while simultaneously developing an interactive e-learning environment for students;

Still another object of the present invention is to provide a Method of Reiterative Enquiry that provides a public network of high quality digital instruction.

Still another object of the present invention is to provide a Method of Reiterative Enquiry that develops individualized e-portfolios that follow students throughout their education.

Still another object of the present invention is to provide a Method of Reiterative Enquiry that provides students and teachers access to secure, easy to use collaboration features.

Still another object of the present invention is to provide a Method of Reiterative Enquiry that provides administrators collaborative tools for educator evaluation.

Still another object of the present invention is to provide a Method of Reiterative Enquiry that provides to teachers access to Professional Learning Networks.

Still another object of the present invention is to provide a Method of Reiterative Enquiry that streamlines available web 2.0 tools in one easy to use system.

Still another object of the present invention is to provide a Method of Reiterative Enquiry that encourages problem solving, creativity, innovation and invention through collaborative real-world learning experiences.

Still another object of the present invention is to provide a Method of Reiterative Enquiry that may be easily and efficiently manufactured and marketed to the consuming public.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

In referring to the drawings,

FIG. 1 is a left portion of a flowchart of the preferred embodiment of the present invention;

FIG. 2 is a center portion of the flowchart of the preferred embodiment of the present invention, generally located to the right of FIG. 1; and,

FIG. 3 is a right portion of the flowchart of the preferred embodiment of the present invention, generally located to the right of FIG. 2.

The same reference numerals refer to the same parts throughout the various figures.

### DESCRIPTION OF THE PREFERRED EMBODIMENT

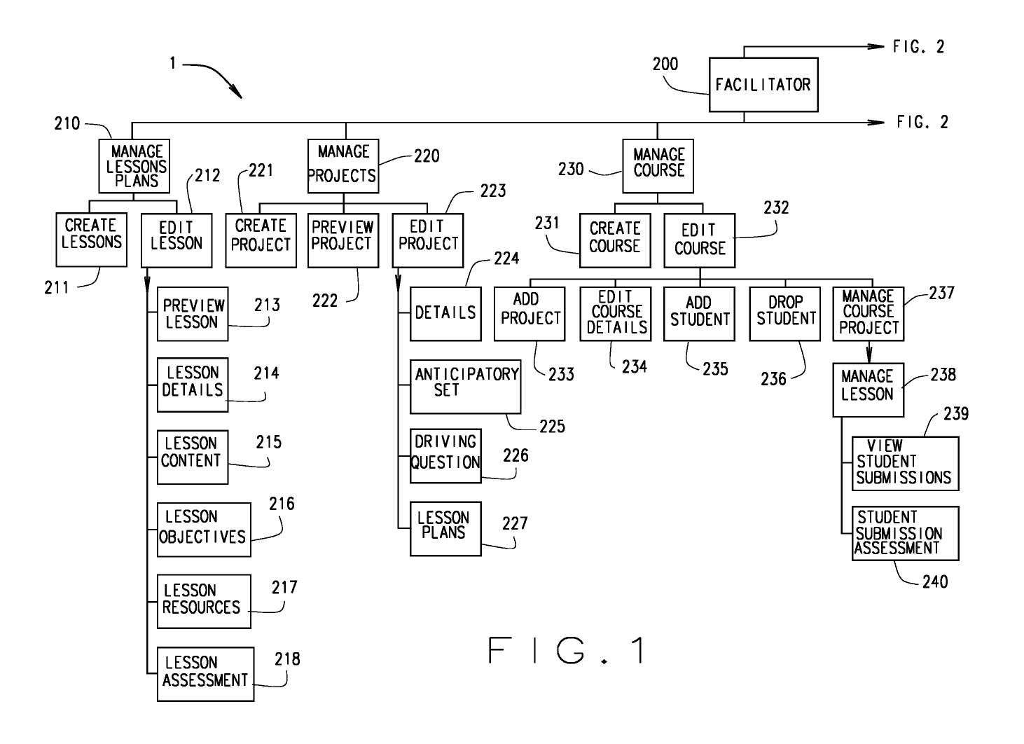

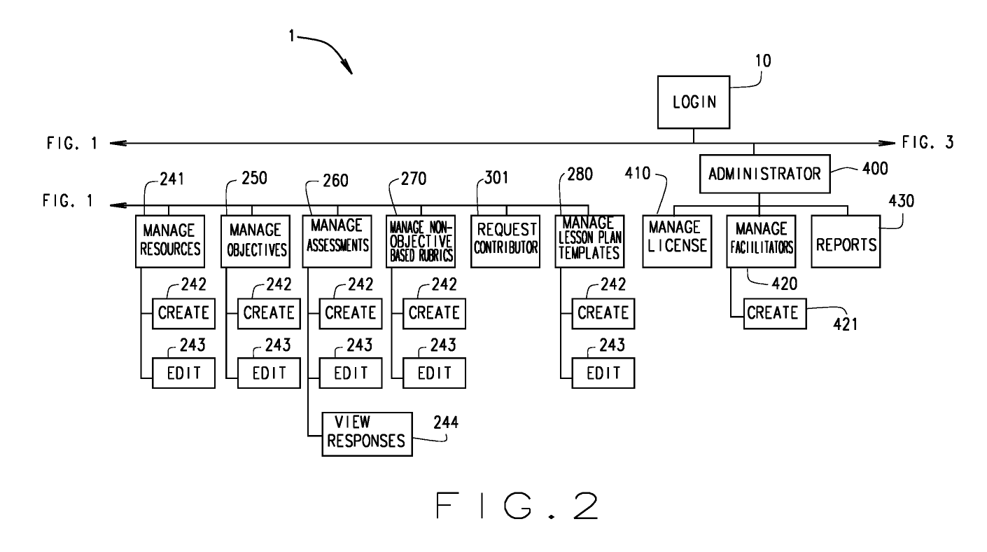

Referring now to the drawings, and particularly to FIGS. 1-3, a preferred embodiment of the Method of Reiterative Enquiry, or Personalized Learning Network, is shown by the reference numeral 1. A user logs into the invention 1 at a login screen 10, as later shown in FIG. 2. The login uses a username and password and from that information, the invention determines the class of user. A user may be a student 100, a facilitator 200, a contributor 300, or an administrator 400. The user roles will have further definition in the description that follows. Each user then interacts with the modules of the invention, a user module, a content module, a database module, a network module, and an analytics engine module. The analytics engine module measures performance of the users and the content to improve both. A user logged in as a facilitator 200, primarily a teacher, brings us to FIG. 1. FIG. 1 is the left of three portions of a flowchart. The flowchart extends across three printed pages from left to right. This description generally follows that left to right flow.

Once logged in, as at 200, a facilitator may perform many functions utilizing the invention as shown in FIGS. 1, 2. The facilitator can manage lesson plans as at 210 where a lesson plan teaches a piece of an academic subject, manage projects as at 220 where a project guides work of students who learn during that work, manage courses as at 230 where a course is an academic subject for a defined term longer than one month, and additional functions related to FIG. 2. Lessons, projects, and courses fall within the word content as used in this specification and its appended claims. Further, the present invention allows a facilitator to write curriculum and content, so that the content remains under the ownership of the facilitator but not the network upon which the invention operates.

A facilitator, most likely a teacher, begins to manage lessons as at 210, with creating a lesson as at 211. The facilitator may use his creativity, goals of instruction, and the technology available to package a piece of an academic subject for dissemination and retention by students. A lesson has various details, content related to the subject, objectives for a student to meet, resources to accomplish the lesson, and an assessment of student progress during and after a lesson. Having created a lesson, a facilitator may then edit it as at 212. Editing involves taking the material of a lesson and fine tuning parts of it as opposed to entirely rewriting it, which is more of creating a lesson. Within the editing function, a facilitator may preview a lesson as at 213, inspect the lesson details as at 214, view the lesson content as at 215, view the lesson objectives as at 216, assemble the lesson resources as at 217, and conduct a lesson assessment as at 218.

Building on a lesson or two, a facilitator may impose a project upon students. A project provides a task to a student and accomplishing the task instructs the student further in a subject. A facilitator serving as a teacher once more manages a project as at 220 and starts with creating the project as at 221. A project also has various details, an anticipatory set, a driving question, and related lesson plans. As above, the facilitator may use his creativity, goals of instruction, the technology available, and the lessons completed to date by students to prepare a project for completion and retention by students. Having developed a project, a facilitator may then edit it as at 223. Editing involves taking the materials, requirements, and objectives of a project but fine tuning parts of it, short of rewriting it. Within the editing function 223, a facilitator may inspect the project details as at 224, view the anticipatory set as at 225, view the driving question as at 226, and assemble related lesson plans 227 for the project. Following either creation of a project or editing of a project, a facilitator may preview a project as at 222. During the preview, a facilitator may view the project details from which students move to complete the task of a project.

Academic subjects have their complexities and later concepts often build upon initial information. Most academic subjects call for exposure to material over a lengthy period of time so that students may comprehend the material. A subject studied over a time period becomes a course. A facilitator serving as a teacher once more manages a course as at 230 and starts with creating the project as at 231.

A course also has various details, student enrollment and disenrollment, possibly a course project, and related lesson plans. Once more, the facilitator may use his creativity, goals of instruction, the technology available, and the desired lessons and projects for students to prepare a course for dissemination and retention of a subject by students. Having developed a few lessons in the above manner into a course for a subject, a facilitator may then edit the course as at 232. Editing involves taking the materials, requirements, and objectives of a subject, test, or discipline, but fine tuning parts of it, short of rewriting it. Within the editing function 223, a facilitator may add a project as at 233, edit the course details as at 234, enroll a student in a course as at 235, disenroll a student as at 236, and manage a course project as at 237. A course project also includes managing related lesson plans as at 238 where the course project calls for a large effort by a student to show mastery of a subject. Within the lesson management of 238, a facilitator may view the project submissions of the students as at 239 and also the facilitator may assess a student submission as at 240. Following either creation of a course or its editing, a facilitator may also preview the course, typically through the edit course details screen as at 234. A course generally guides the students through an academic subject for greater than a month, typically for a marking period, such as a quarter, trimester, or semester. During the preview, a facilitator may check and view the course details and objectives that students will learn.

Courses, projects, lessons and objectives reside upon a publicly accessible database on a secure server. The content and resources of courses, projects, lessons and objectives have targeting and indexing applied to them for relevant keyword searches by users.

The present invention also envisions the facilitator users performing additional functions as shown in FIG. 2. Starting from lessons through projects and building courses, facilitators 200 also manage resources as at 241, manage objectives as at 250, manage assessments as at 260, manage non-objective based rubrics as at 270, manage lesson plan templates as at 280, and request a contributor as at 301. Lessons, projects, courses, and other programs in educations use resources such as classrooms, audio visual equipment, computers, shop tools, props, and the like. Often such resources have a finite number, generally less than the number of traditional classrooms in a school. Such resources undergo indirect rationing such that classes share the resource. Sharing of such resources requires management, as at 241. To start managing a resource, the present invention creates, as at 242, a resource with various appropriate details forming a record such as serial number, model, make, weight, and the like. From time to time, the details about a resource must change and the record undergoes editing as at 243.

With resources managed, a facilitator also manages objectives as at 250. An objective appears as the goal, purpose, milestone, and the like for a lesson, project, or course. The facilitator may develop the objectives or school administration at other levels may impose the objectives for a certain subject. A facilitator begins managing objectives by creating, as at 242, an objective. The objective has a record with a name, serial number, and description at a minimum. The facilitator may draft an objective and then feed it into related lesson plans, projects, and courses. Eventually, an objective may undergo improvements, rewording, and the like. A facilitator may edit, as at 243, an objective by opening its record and changing the desired fields. The present invention them propagates the updated record into other lesson plans, projects, and courses in real time.

Objectives often provide a standard against which to measure performance of students. Such measurement of performance also goes by the name assessment. A facilitator also manages assessments as at 260 and starts with creating, as at 242, a record for one assessment. The record may have the testing mechanism, the desired goal, purpose, or number to be assessed, and a comparing mechanism between the test results and the desired goal. As objectives change, an assessment that flows from them also changes as well. A facilitator may edit as at 243 the record of an assessment. Once more the facilitator opens the records and changes the desired fields. The present invention them propagates the updated record into other assessing tools, lesson plans, projects, and courses in real time. Because an assessment involves comparing a test to a goal, a facilitator may view test results, or responses, as at 244. In viewing the responses, a facilitator may gauge progress of students towards a goal, purpose, and the like, and also check the effectiveness of an assessment itself. Collaboration, scoring, feedback, and performance all become aggregated into personal profiles, or records, for individual students and educators.

Educational progress, whether traditional or by e-learning, also receives measurement and tracking for progress against other goals that objectives. Those other goals often become rubrics that a facilitator manages as at 270. A rubric is generally a directive from a higher authority, often separate from progress toward academic goals. A facilitator begins managing rubrics by creating, as at 242, a record for a rubric with its name, serial number, and short description. As in other management efforts described above, a facilitator updates and changes rubrics through editing a rubric's record as at 243.

Facilitators come in many kinds. The typical facilitator appears as a teacher however, principals and school district staff may also have a facilitator role from time to time. District staff may seek to harmonize lessons on an academic subject across various schools. Sharing lesson plans between schools and teachers promotes such harmonization and indirectly lightens the teacher planning burden. Sharing of lesson plans may start earlier in development of lessons by sharing lesson plan templates. Such a template may have over half of a lesson plan complete and a teacher completes the remainder of the lesson plan. A facilitator may manage the lesson plan templates as at 280. The facilitator begins with creating, as at 242, such a template. The template will have a record with a serial number, name, short description, and then content to some degree of completion. Once a template operates, it may encounter changes to its record and a facilitator makes those through the editing as at 243.

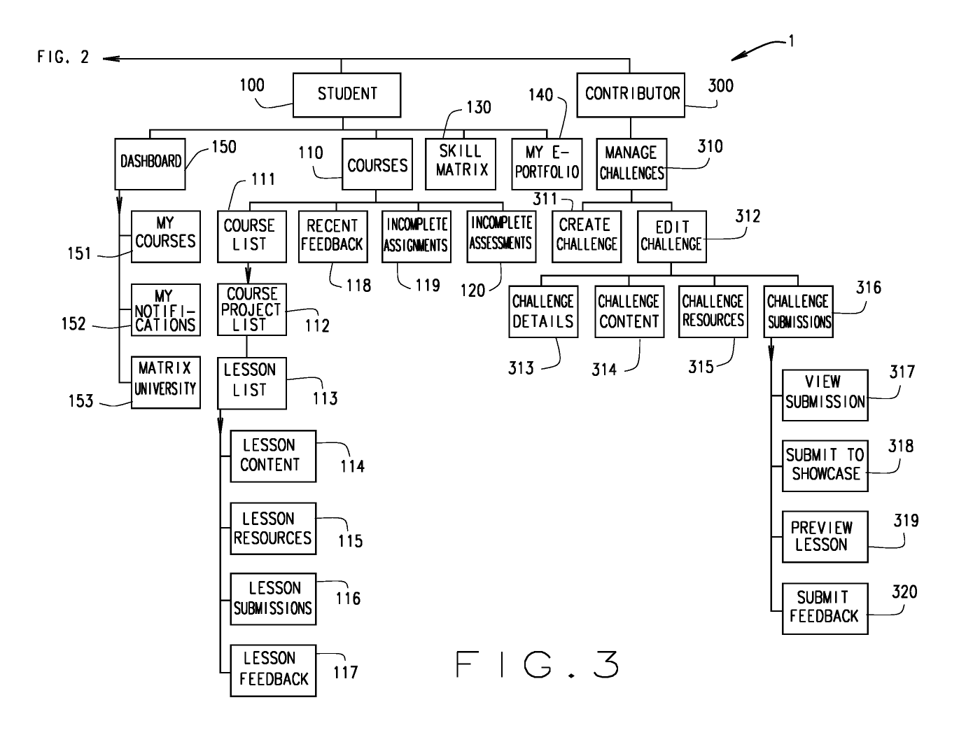

From time to time, a facilitator may identify a lesson plan or other item that calls for more development. A facilitator may request a contributor, as at 301, as later shown and described in FIG. 3, contributor provides content for lesson plans or other documents as well as student feedback. Many times a contributor serves as a Subject Matter Expert. A facilitator may use the invention to communicate with a contributor in a school to develop a lesson plan further. In other situations, the present invention allows a facilitator to use the invention to seek a contributor outside of the school system.

Facilitators, as at 200, generate annual submissions to the public network of the present invention. In exchange for that, they receive access to a Professional Learning Network, and they may then implement and modify existing lessons, projects and courses created by other users of the invention. Every document submitted to the invention will undergo rating and ranking by users—students, teachers, administrators and parents—according to user feedback and thus creating a crowd sourced Learning Network. This network of the invention allows the best of the best learning experiences to rise to the top of the search features.

The system of the invention has a design to allow teachers and administrators to customize a variety of digital resources to fit any curriculum. Lesson construction bends and applies to any subject matter. Individual school districts can create or employ the standards, objectives and skills that fit their needs. Teachers freely use their creativity in lesson design and implementation, as the system serves to enhance their valuable skills and knowledge. Students benefit from a standards based approach that provides access to a network of powerful learning experiences showcased through individualized e-portfolios, profiles, and records.

Having described facilitators 200 above, another user for the invention is an administrator 400. An administrator may be a boss of a facilitator or an administrator may have a staff role with a school or school district. For the present invention an administrator manages many of the administrative functions key to the invention. An administrator manages a license as at 410 between the users and the operator of the present invention, manages the facilitators 420 using the invention including their professional development, and generates reports 430. Generally the present invention resides upon servers of the operating company. The operating company extends a license to its school district contracting parties. The license has various terms and select features unique to each school district. In coordination with the operating company, the administrator supervises compliance with the license terms and plans for renewal of the license with the operating company as that approaches. As described above, the present invention has many facilitators who utilize it. The administrator supervises the use of the invention by the facilitators as at 420. The administrator vets and approves a person to serve as a facilitator. After approving a person, an administrator creates a facilitator record as at 421. The facilitator record includes a username, a password, an account number, and a log. Similar to administrators in other districts, companies, and agencies, the invention foresees the administrator 400 as running various reports as at 430. The reports track the activity of facilitators, provide progress of students towards objectives, and the status of the invention among other things.

Administrators further utilize data generated within the system to streamline the evaluation process, which ensures educator effectiveness, and promotes high quality instruction. The technological revolution has opened opportunities to streamline education in a manner that informs instruction and empowers student learning. E-learning experiences connect students with tools of exploration and production, and to each other as well. The classroom of the future must reach beyond school walls to connect with the real world. The present invention changes the landscape of education by transitioning teachers from the traditional “sit and get” mentality prevalent in education to more project based, hands on learning involving application, evaluation, and acquisition of real world skills.

And turning to FIG. 3, though described here to follow the flow chart, a student 100 remains a key participant with the present invention and thus has a lower reference number. For without students, the present invention and the other users have limited purpose. The present invention provides a student who has logged in with a variety of items at his use. Upon logging in, a student sees a dashboard as at 150 on his screen. The student also has displayed to him courses as at 110, a skill matrix as at 130, and a My e-Portfolio as at 140.

Upon a student's dashboard as at 150, the present invention provides a My Courses tab as at 151, a My Notifications tab as at 152 or notification system, and a Matrix University tab as at 153. The My Courses tab identifies the courses—previously made by a facilitator as at 230—in which a student has enrolled as at 235. The My Courses tab provides a short summary of each course and its course number. The My Notifications tab provides a list of messages sent to the student by another user, such as a facilitator about the student's progress in a particular course. The message notifications seek to prompt the student to act. And, Matrix University shows the other lessons, projects, and courses available to the student and tracks those that the student has completed.

The courses, as at 110, displayed to the student show various things beginning with a course list as at 111. The courses also include recent feedback as at 118, incomplete assignments as at 119, and incomplete assessments as at 120. Within the course list, the student also has shown to him a course project list as at 112 and then a lesson list as at 113. The course project list describes materials provided to the student for a project, materials that a student may have to obtain, other resources for the project, and a timeline about the project. The lesson list provides further information to the student for a particular lesson such as the lesson content as at 114, the lesson resources as at 115, the lesson submissions as at 116, and the lesson feedback as at 117. Here, the lesson content has the academic subject matter the student is to master so as to complete the lesson. The lesson resources identify the materials and other items necessary to complete the lesson as suggested by the facilitator, as at 241. The lesson submissions then inform the student what he is due to complete and then send to a facilitator for evaluation, as previously shown at 239. The submissions could be quizzes, tests, papers, and other student work as assigned by a facilitator. And, the lesson feedback requests the comments of the student upon the lesson, its subject matter, its presentation, its usefulness, and the like. The feedback undergoes review by a facilitator to improve the lesson for future use.

Returning to the courses as at 110, the recent feedback, as at 118, shows a short index to feedback of 117 that the student has provided and feedback that has become overdue. This listing of overdue feedback prompts the student to complete it. The courses also show the incomplete assignments as at 119 of the student and the incomplete assessments as at 120 of the student as well. By showing those two items, the invention seeks to help students battle their classic foe of procrastination. A showing of the incomplete items, prompts a student to act.

Along with the dashboard as at 150 and the courses as at 110, the student also has his skill matrix as at 130 and his My E-Portfolio as at 140. The skill matrix lists the skills presented to the student through his various lessons and shows his progress towards mastering those skills. This matrix updates in real time as a student completes a lesson and its assessment. And the E-Portfolio collects the works completed and submitted by the student for his various lessons during the usage of the present invention.

And our last user to be described is the contributor as at 300 who adds content related to what they do or know. The present invention accumulates the content from various contributors through their lesson plans, projects, and courses so the content database builds and grows. Educators, one of the facilitators, can build their own lessons, projects and courses, may access and apply proven lessons from rated and ranked options, or they can modify an existing lesson, project, or course to fit their need, as in 212, 223, 232 respectively.

Approved contributors provide a real world connection by adding resources, lessons and projects related to their area of expertise. Contributors may include parents, teachers, administrators, government officials, industry experts and anyone else who is interested in enhancing the educational experience. They may submit individual lessons, design briefs, problem statements, or projects that can then be submitted through the blended learning environment. Digital collaboration in global problem solving experiences not only bring students together through the e-learning environment, but often culminate in solutions that are then developed and presented to contributors. A global problem solving showcase will allow teams to develop, prototype, and promote their ideas.

The contributors also manage challenges as at 310 where a challenge provides a task for a student to accomplish. Challenge management begins with creating a challenge as at 311 that has details, content, resources, and submissions. Once created, a challenge undergoes editing as at 312 where the challenge details can be changed as at 313, the challenge content has adjustment as at 314 and see also 215, the challenge resources appear listed as at 315, see also 217 and 241, and the challenge submissions appear with their deadline as at 316. A challenge submission can be in many forms such as quizzes, tests, lab reports, papers, videos, and the like. A student who completes a challenge then provides a submission to the contributor, or other user who reviews it as at 317. The review includes whether the submission meets the required form and deadline and a qualitative review of it. A submission, of exceptional quality, or merit, then advances to a showcase as at 318. The showcase operates as a collection of outstanding student work that other students and users may see, may hear, or both. A showcase may appear as the winner of a game. In the challenge submission, a contributor may also preview lessons, as at 319, based upon a contributed item. And a contributor may submit feedback, as at 320, to students who participate in a challenge whether that is a letter grade, pass/fail or other indicator of feedback.

The present invention represents a comprehensive, research based, intuitive and flexible approach to lesson design, project implementation and course creation. The present invention combines the most powerful elements of cloud computing and Web 2.0 technology with an intelligent database, providing a single virtual location for facilitating a digital learning experience. Courses, projects, lessons and objectives are loaded by contributors into the public database with content and resources targeting relevant keyword searches.

The present invention also utilizes game theory, through gamifamification, which utilizes game like thinking to provide feedback and intrinsic motivation throughout the learning experience. Contributors, facilitators, administrators, parents and students are all involved in the gaming experience. Points are assigned and distributed for contribution, creation and completion of experiences from the present invention such as lessons, projects, challenges, courses, and the like. Trophies are awarded for completion of lessons, projects, assessments, courses, and student application of specific standards, objectives, and skills. Through the present invention contributors gain access to a wider audience, facilitators gain status in the system, students gain access to enhanced network features, and parents gain direct access to their student's learning experiences thus incentivizing progressive development in all areas of education.

While a preferred embodiment of the Method of Reiterative Enquiry has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Although providing a network of high quality digital instruction that both enhances teacher performance, and increases student achievement.

places has been described, it should be appreciated that the Method of Reiterative Enquiry, or Personalized Learning Network, herein described is also suitable for military training, professional development, continuing adult education, and the like.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like —when they appear—are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

We claim:

1. A method of enhancing learning by students across a computer network, comprising:
providing at least one computer server;
providing at least one database upon said at least one computer server;
designating users to access said at least one database;
collecting content upon said at least one database;
measuring performance of users with the content upon said at least one database; and,
allocating resources through said at least one database and said collecting of content wherein said resources adapted to include at least one of classrooms, audio visual equipment, computers, shop tools, props, books, tangible documents, intangible documents, video files, and audio files.

2. The method of enhancing learning of claim 1 further comprising:
designating at least one of said users as a student;
measuring performance of said student with the content; and,
collecting feedback from said student about the content.

3. The method of enhancing learning of claim 1 further comprising:
designating at least one of said users as a student;
designating at least one of said users as a facilitator;
deploying a plurality of lesson drafting tools for said facilitator to utilize in creating lessons; and,
collecting feedback about the lessons.

4. The method of enhancing learning of claim 1 further comprising:
designating at least one of said users as a student;
designating at least one of said users as a facilitator;
designating one of said users as an administrator;
deploying a plurality of management tools for said administrator to utilize in vetting facilitators, in evaluating facilitators, in preparing professional development of facilitators, and in managing a license to said at least one database upon said at least one server;
deploying a plurality of reporting tools wherein said administrator assesses progress of said at least one student towards objectives using the content; and,
collecting feedback upon the content.

5. The method of enhancing learning of claim 4 further comprising:
said deploying a plurality of reporting tools including disseminating information about said method and said users suitable to a wider community.

6. The method of enhancing learning of claim 3 further comprising:
said collecting of feedback including rating of lessons and reporting the ratings to certain classes of users; and,
each of said lessons having a record within said at least one database module, an objective for a user to master, and each lesson following a template.

7. The method of enhancing learning of claim 6 further comprising:
measuring performance of the user with the content;
said measuring performance forming a game where each user has at least one point provided to a record of that user upon completing an objective of a lesson, the game comparing a user's progress towards a goal of said method, and showcasing at least one user who has accumulated a certain amount of points.

8. The method of enhancing learning of claim 7 further comprising:
said deploying a plurality of lesson drafting tools using results of a game for a facilitator to personalize lessons for a student in real time.

9. The method of enhancing learning of claim 1 further comprising:
each user has a predetermined level of access into said at least one secure server;
said collecting content upon said at least one database including targeting and indexing of content therein; and,
said method provides ready searching of content collected by it upon demand by a user.

10. A method ending procrastination by students on lengthy learning tasks, said method assisting students in navigation the learning tasks, said method operating across a computer network, said method comprising:
providing a user module, said user module having classes of users;
providing a content module, said content module having items for learning;
operating a database module, said database module being in operative communication with said user module and said content module;
operating a network module, said network module providing communication for said user module across the computer network; and,
utilizing an analytics engine module, said analytics engine module measuring performance of said classes of users and said content module.

11. The method ending procrastination by students of claim 10 further comprising:
said classes of users adapted to include administrator, facilitator, student, parent, and contributor;
wherein each of said users has a record within said database module;
wherein an administrator operates said method, wherein a facilitator organizes items for learning by students into said content module, wherein a student reviews said content module through said database module, wherein a parent reviews said analytics engine module regarding a specific student, and wherein a contributor provides items for learning into said content module.

12. The method ending procrastination by students of claim 10 further comprising:
said analytics engine module receiving feedback from said classes of users upon said content module through said database module, rating items for learning within said content module utilizing said feedback, and reporting the ratings to certain classes of users.

13. The method ending procrastination by students of claim 12 further comprising:
each item for learning within said content module having a record within said database module, each item for learning record including an objective for a user to master, and each item for learning record following a template;
said analytics engine module forming a game where each user has at least one point provided to a record of that user upon completing an objective of a item for learning record, measuring the game by comparing a user's progress towards a goal of said method, and showcasing at least one user who has accumulated a certain amount of points.

14. The method ending procrastination by students of claim 13 further comprising:
said comparing progress of a user towards a goal including a matrix and a notification system;
wherein said matrix shows the items for learning available to a user and tracks the items for learning that the user has completed; and,
wherein said notification system provides a list of messages to the user that prompt the user to act toward an item for learning and its objective.

15. The method ending procrastination by students of claim 11 further comprising:
said user module, said content module, said database module, said analytics engine module, and said network module operating upon at least one secure server;
wherein each class of user has a predetermined level of access into said at least one secure server.

16. The method ending procrastination by students of claim 15 further comprising:
each of said user module, said content module, said database module, said analytics engine module, and said network module including targeting and indexing of records contained within it, wherein said method provides ready searching of each of said modules upon demand by a user.

17. The method ending procrastination by students of claim 11 further comprising:
said providing a database module receiving content from said users and storing said content for access and management by said content module and said analytics engine module; and,
said providing a database module accumulating content from said users and expanding proportionally.

18. The method ending procrastination by students of claim 11 further comprising:
said providing a content module receiving a plurality of lesson plans from said facilitators wherein each of said lesson plans organizes content for learning by said students; and,
said providing an analytics engine module tracks student performance upon said lesson plans and indicates a student, a lesson plan, or a facilitator to an administrator.

19. A method of operating a personalized learning network that ends procrastination by students on lengthy learning tasks, said method assisting students in navigating the learning tasks, said method comprising:
providing a user module, said user module having classes of users, said classes of users adapted to include administrator, facilitator, student, parent, and contributor, wherein each of said users has a record;
providing a content module, said content module having items for learning, wherein each item for learning has a record, each item for learning record including an objective for a user to master, and each item for learning record following a template;
operating a database module, said database module being in operative communication with said user module and said content module, said database module including said record of each user and said record of each item for learning;
operating a network module, said network module providing communication for said user module across the network; and,
utilizing an analytics engine module, said analytics engine module measuring performance of said classes of users and said content module;
wherein an administrator operates said method, wherein a facilitator organizes items for learning by students into said content module, wherein a student reviews said content module through said database module, wherein a parent reviews said analytics engine module regarding a specific student, and wherein a contributor provides items for learning into said content module;
said analytics engine module receiving feedback from said classes of users upon said content module through said database module, rating items for learning within said content module utilizing said feedback, reporting the ratings to certain classes of users, forming a game where each user has at least one point provided to a record of that user upon completing an objective of an item for learning record, measuring the game by comparing a user's progress towards a goal of said method, and showcasing at least one user who has accumulated a certain amount of points;
each of said user module, said content module, said database module, said analytics engine module, and said network module including targeting and indexing of records contained within it, wherein said method provides ready searching of each of said modules upon demand by a user;
said providing a database module receiving content from said users, storing said content for access and management by said content module and said analytics engine module, and accumulating content from said users wherein said database module expands proportionally;
said providing a content module receiving a plurality of lesson plans from said facilitators wherein each of said lesson plans organizes content for learning by said students; and,
said providing an analytics engine module that tracks student performance upon said lesson plans and indicates a student, a lesson plan, or a facilitator to an administrator.

20. The method of operating a personalized learning network of claim 19 further comprising:
said comparing progress of a user towards a goal including a matrix and a notification system;
wherein said matrix shows the items for learning available to a user and tracks the items for learning that the user has completed; and,
wherein said notification system provides a list of messages to the user that prompt the user to act toward an item for learning and its objective.
